(19) United States
(12) Patent Application Publication
(10) Pub. No.: US 2012/0312032 A1
(43) Pub. Date: Dec. 13, 2012

(54) CRYOPUMP AND CRYOGENIC REFRIGERATOR

(75) Inventor: Hidekazu Tanaka, Tokyo (JP)

(73) Assignee: SUMITOMO HEAVY INDUSTRIES, LTD., Tokyo (JP)

(21) Appl. No.: 13/490,889

(22) Filed: Jun. 7, 2012

(30) Foreign Application Priority Data
Jun. 8, 2011 (JP) 2011-128662

(51) Int. Cl. F25B 9/00; B01D 8/00

(52) U.S. Cl. 62/6; 62/55.5

(57) ABSTRACT

A refrigerator includes two displacers which are longitudinally adjacent to each other and the high temperature displacer includes a main compartment and an auxiliary compartment for a regenerator material. A direct passage for operating gas is formed between the two displacers. A cryopump includes a low temperature cryopanel, a radiation shield which is cooled to a higher temperature than that of the low temperature cryopanel, and the refrigerator.

### BACKGROUND OF THE INVENTION

1. Field of the Invention

The present invention relates to a cryopump and a cryogenic refrigerator.

2. Description of the Related Art

A cryopump having a refrigerator wherein a flow passage of operating gas at a joint between a first displacer and a second displacer is branched into two operating gas flow passages is known. The first operating gas flow passage connects from the low-temperature end of a first regenerator to a first expansion room. The second operating gas flow passage directly connects from the low-temperature end of the first regenerator to a second regenerator. The second operating gas flow passage allows apart of the gas flowing into the second regenerator to flow into the second regenerator without passing through the first expansion room.

### SUMMARY OF THE INVENTION

According to an aspect of the present invention, there is provided a cryopump including: a low temperature cryopanel; a high temperature cryopanel cooled to a temperature higher than that of the low temperature cryopanel; and a refrigerator arranged to provide a low temperature cooling position for cooling the low temperature cryopanel and a high temperature cooling position for cooling the high temperature cryopanel. The low temperature cooling position and the high temperature cooling position are arranged longitudinally. The refrigerator includes a first displacer and a second displacer longitudinally adjacent to a low temperature side of the first displacer. The first displacer includes a low temperature end, having a direct flow passage for guiding operating gas from a main regenerator of the first displacer toward a regenerator of the second displacer, and an auxiliary regenerator provided in the direct flow passage.

According to another aspect of the present invention, there is provided a cryogenic refrigerator including a low temperature displacer and a high temperature displacer adjacent to each other in a longitudinal direction. The high temperature displacer includes a main compartment and an auxiliary compartment for accommodating a regenerator material. The auxiliary compartment has a cross-sectional area in a plane perpendicular to the longitudinal direction smaller than that of the main compartment. The auxiliary compartment is provided to allow gas to flow between the main compartment and the low temperature displacer.

According to another aspect of the present invention, there is provided a cryogenic refrigerator including a regenerator including cooling paths for cooling operating gas from a high temperature side to a low temperature side. The regenerator is configured such that a cooling path for the operating gas toward another regenerator adjacent thereto is longer than a cooling path for the operating gas toward an expansion space adjacent to the regenerator.

### BRIEF DESCRIPTION OF THE DRAWINGS

Embodiments will now be described, by way of example only, with reference to the accompanying drawings, which are meant to be exemplary, not limiting, and wherein like elements are numbered alike in several figures, in which:

FIG. 1 schematically shows a cryopump according to an exemplary embodiment of the present invention;

FIG. 2 shows a substantial part of a refrigerator according to the exemplary embodiment of the present invention;

FIG. 3 shows flows of operating gas during a gas intake process in the refrigerator according to the exemplary embodiment of the present invention;

FIG. 4 shows flows of operating gas during a gas release process in the refrigerator according to the exemplary embodiment of the present invention;

FIG. 5 shows flows of operating gas during a gas intake process in another exemplary refrigerator; and

FIG. 6 shows flows of operating gas during a gas release process in the exemplary refrigerator.

### DETAILED DESCRIPTION OF THE INVENTION

The invention will now be described by reference to the preferred embodiments. This does not intend to limit the scope of the present invention, but to exemplify the invention.

A cryopump which is one of the typical applications of cryogenic refrigerators includes cryopanels cooled to different temperature levels and it may be desired that a temperature difference is comparatively large in some cases. There is a certain degree of limit to spatial arrangement of a low temperature cryopanel and a high temperature cryopanel. For example, in order to suppress an effect of radiation heat from outside, the low temperature cryopanel is surrounded by the high temperature cryopanel. Such a limit also gives the effect to a structure of the refrigerator for cooling the cryopanels, i.e., a positional relation between a cooling position for providing a low cooling temperature and a cooling position for providing a high cooling temperature. The positional relation is one of the main factors that determine the temperature difference between the two.

According to an aspect of the invention, it is desirable, for example, to provide a cryogenic refrigerator that can be more suitably designed for an application in which the refrigerator is to be utilized, and a cryopump utilizing the refrigerator.

In an exemplary embodiment of the invention, in order to cool a low temperature cryopanel 60 and a high temperature cryopanel 40, a refrigerator 50 for the cryopump 10 provides a low temperature cooling position 14 and a high temperature cooling position 13 with an arrangement adaptable to respective panels. In the refrigerator 50, a direct channel is formed from a first displacer 68 on a high temperature side to a second displacer 70 on a low temperature side. An auxiliary regenerator 136 is added to the direct channel. Operating gas is supplied from the first displacer 68 to the second displacer 70 through a main regenerator 134 and the auxiliary regenerator 136. To a first expansion space 94 adjacent to the first displacer 68, the operating gas is supplied from the main regenerator 134 without passing through the auxiliary regenerator 136.

In this way, the temperature of the gas to be supplied to the first expansion space 94 can become relatively high and the temperature of the gas to be supplied to the second displacer 70 can become relatively low. This contributes to increase of cooling capability of a second stage of the refrigerator. Further, a temperature difference between the low temperature cooling position 14 and the high temperature cooling position 13 can be increased without redesigning the external dimensions of the refrigerator 50.

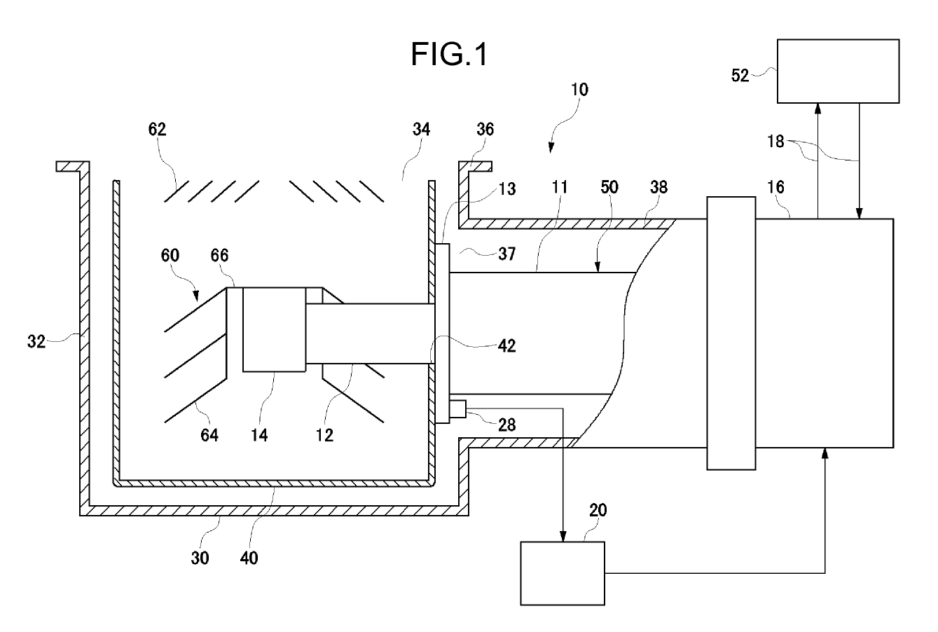

FIG. 1 schematically shows the cryopump 10 according to an exemplary embodiment of the invention. The cryopump 10 is mounted to a vacuum chamber of an apparatus, such as an ion implantation apparatus, a sputtering apparatus, or the like that requires a high vacuum environment. The cryopump 10 is used to enhance the degree of vacuum in the vacuum chamber to a level required in a desired process. The cryopump 10 is configured to include a cryopump housing 30, a radiation shield 40, and the refrigerator 50.

The refrigerator 50 is, for example, a Gifford-McMahon refrigerator (so-called GM refrigerator) or the like. The refrigerator 50 is provided with a first cylinder 11, a second cylinder 12, a first cooling stage 13, a second cooling stage 14, and a valve drive motor 16. The first cylinder 11 and the second cylinder 12 are connected in series. The first cooling stage 13 is installed on one end of the first cylinder 11 where the first cylinder 11 is connected with the second cylinder 12. The second cooling stage 14 is installed on the second cylinder 12 at the end that is farthest from the first cylinder 11.

The refrigerator 50 shown in FIG. 1 is a two-stage refrigerator and achieves lower temperature by combining two cylinders in series. The refrigerator 50 may be a three-stage refrigerator that connects three stage cylinders in series, or may be a multiple-stage refrigerator having more than three stages. The refrigerator 50 is connected to a compressor 52 through refrigerant pipes 18.

The compressor 52 compresses refrigerant gas (i.e., operating gas) such as helium or the like, and supplies the gas to the refrigerator 50 through the refrigerant pipe 18. The refrigerator 50 cools the operating gas by allowing the gas to pass through regenerators. The refrigerator 50 further cools the gas by expanding the gas in an expansion chamber inside the first cylinder 11 and in an expansion chamber in the second cylinder 12. The regenerators are installed inside the expansion chambers. Thereby, the first cooling stage 13 installed on the first cylinder 11 is cooled to a first cooling temperature level while the second cooling stage 14 installed on the second cylinder 12 is cooled to a second cooling temperature level lower than the first cooling temperature level. For example, the first cooling stage 13 is cooled to about 65-120 K, or more preferably 80-100 K, while the second cooling stage 14 is about 10-20 K.

In this way, the refrigerator 50 provides the low temperature cooling position for cooling the low temperature cryopanel and the high temperature cooling position for cooling the high temperature cryopanel. The low temperature cooling position and the high temperature cooling position are arranged along the longitudinal direction of the cylinders, that is, the alignment direction of the cylinders. One or a plurality of middle cooling positions that provide middle cooling temperature may be arranged between the low temperature cooling position and the high temperature cooling position.

The operating gas, which has absorbed heat by expanding in the respective expansion chambers and cooled respective cooling stages, passes through the regenerators again and is returned to the compressor 52 through the refrigerant pipe 18. The flow of the operating gas from the compressor 52 to the refrigerator 50 and from the refrigerator 50 to the compressor 52 is switched by a rotary valve (not shown) in the refrigerator 50. A valve drive motor 16 rotates the rotary valve by supplying power from an external power source.

A control unit 20 for controlling the refrigerator 50 is provided. The control unit 20 controls the refrigerator 50 based on the cooling temperature of the first cooling stage 13 or the second cooling stage 14. For this purpose, a temperature sensor 28 may be provided on the first cooling stage 13 or the second cooling stage 14. The control unit 20 may control the cooling temperature by controlling the driving frequency of the valve drive motor 16. For this purpose, the control unit 20 may include an inverter for controlling the valve drive motor 16. The control unit 20 may be configured to control the compressor 52. The control unit 20 may be integrated with the cryopump 10 or configured as a control device separate from the cryopump 10.

The cryopump 10 illustrated in FIG. 1 is a so-called horizontal-type cryopump. In the horizontal-type cryopump, the second cooling stage 14 of the refrigerator is generally inserted into the radiation shield 40 along the direction that intersects (usually orthogonally) with the axis of the cylindrical radiation shield 40. The present invention is also applicable to a so-called vertical-type cryopump in a similar way. In the vertical-type cryopump, the refrigerator is inserted along the axis of the radiation shield.

The cryopump housing 30 has a portion 32 formed into a cylindrical shape (hereinafter, referred to as a “trunk portion”), one end of which being provided with an opening and the other end being closed. The opening is provide as an inlet 34 through which a gas to be evacuated from the vacuum chamber of the sputtering apparatus or the like enters. The inlet 34 is defined by the interior surface of the upper end of the trunk portion 32 of the cryopump housing 30. On the trunk portion 32 also is formed an opening 37 for inserting the refrigerator 50. One end of a cylindrically-shaped refrigerator container 38 is fitted to the opening 37 in the trunk portion 32 while the other end thereof is fitted to the housing of the refrigerator 50. The refrigerator container 38 contains the first cylinder 11 of the refrigerator 50.

At the upper end of the trunk portion 32 of the cryopump housing 30, a mounting flange 36 extends outwardly in the radial direction. The cryopump 10 is mounted to the vacuum chamber, which is a volume to be evacuated, of the sputtering apparatus or the like by using the mounting flange 36.

The cryopump housing 30 is provided in order to separate the inside of the cryopump 10 from the outside thereof. As described above, the cryopump housing 30 is configured to include the trunk portion 32 and the refrigerator container 38. The trunk portion 32 and the refrigerator container 38 are gastight and the respective insides thereof are maintained at a common pressure. The exterior surface of the cryopump housing 30 is exposed to the environment outside the cryopump 10 during the operation of the cryopump 10, i.e., even during operation of the refrigerator.

Therefore the exterior surface of the cryopump housing 30 is maintained at a temperature higher than that of the radiation shield 40. The temperature of the cryopump housing 30 is typically maintained at an ambient temperature. Herein, the ambient temperature refers to a temperature of a place where the cryopump 10 is installed or a temperature close to the temperature. The ambient temperature may be, for example, at or around room temperature.

The radiation shield 40 is arranged inside the cryopump housing 30. The radiation shield 40 is formed as a cylindrical shape, one end of which being provided with an opening and the other end being closed, that is, a cup-like shape. The radiation shield 40 may be formed as a one-piece cylinder as illustrated in FIG. 1. Alternatively, a plurality of parts may form a cylindrical shape as a whole. The plurality of parts may be arranged so as to have a gap between one another.

The trunk portion 32 of the cryopump housing 30 and the radiation shield 40 are both formed as substantially cylindrical shapes and are arranged concentrically. The inner diameter of the trunk portion 32 of the cryopump housing 30 is larger than the outer diameter of the radiation shield 40 to some extent. Therefore, the radiation shield 40 is arranged in the cryopump housing 30 without contact, spaced reasonably apart from the interior surface of the trunk portion 32 of the cryopump housing 30. That is, the exterior surface of the radiation shield 40 faces the interior surface of the cryopump housing 30. The shapes of the trunk portion 32 of the cryopump housing 30 and the radiation shield 40 are not limited to cylindrical shapes but may be tubes having a rectangular or elliptical cross section, or any other cross section. Typically, the shape of the radiation shield 40 is analogous to the shape of the interior surface of the trunk portion 32 of the cryopump housing 30.

The radiation shield 40 is provided as a high temperature cryopanel to protect both the second cooling stage 14 and a low temperature cryopanel 60, which is thermally connected to the second cooling stage 14, from radiation heat mainly from the cryopump housing 30. The radiation shield 40 surrounds the low temperature cryopanel 60. The second cooling stage 14 is arranged inside the radiation shield 40, substantially on the central axis of the radiation shield 40. The radiation shield 40 is fixed to the first cooling stage 13 so as to be thermally connected to the stage 13, and the radiation shield 40 is cooled to a temperature equal to that of the first cooling stage 13.

The low temperature cryopanel 60 includes, for example, a plurality of panels 64. Each of the panels 64 has a shape of the side surface of a truncated cone, i.e., an umbrella-like shape. Each panel 64 is attached to a panel mounting member 66 that is fixed to the second cooling stage 14. Typically, an adsorbent (not shown) such as charcoal is provided on each panel 64. The adsorbent adheres to, for example, the back face of the panel 64.

The panel mounting member 66 has a cylindrical shape, one end of which being closed and the other end being open. The closed end portion of the member is mounted at the upper end of the second cooling stage 14, and the cylindrical side surface of the member extends toward the bottom of the radiation shield 40 so as to surround the second cooling stage 14. The plurality of the panels 64 are attached to the side surface of the panel mounting member 66 with spaces between one another. An opening for inserting the second cylinder 12 of the refrigerator 50 is formed on the side surface of the panel mounting member 66. Alternatively, the panel mounting member 66 may include the end portion to be mounted to the second cooling stage 14 and a flat plane for mounting the panels and extending from the end portion toward the bottom of the radiation shield 40.

A baffle 62 is provided in the inlet of the radiation shield 40 in order to protect both the second cooling stage 14 and the low temperature cryopanel 60, which is thermally connected to the stage 14, from radiation heat emitted from the vacuum chamber, etc. The baffle 62 is formed as, for example, a louver structure or a chevron structure. The baffle 62 may be formed as circular shapes concentrically arranged around the central axis of the radiation shield 40 or may be formed in another shape such as a lattice or the like. The baffle 62 is mounted at the opening end of the radiation shield 40 and cooled to a temperature comparable to that of the radiation shield 40. A gate valve (not shown) may be provided between the baffle 62 and the vacuum chamber. The gate valve is closed, for example, when the cryopump 10 is regenerated, and the gate valve is opened when the vacuum chamber is evacuated by the cryopump 10.

A refrigerator mounting opening 42 is formed on the side surface of the radiation shield 40. The refrigerator mounting opening 42 is formed on the side surface of the radiation shield 40 at the middle in the central axis of the radiation shield 40. The refrigerator mounting opening 42 of the radiation shield 40 is provided coaxially with the opening 37 of the cryopump housing 30. The second cylinder 12 and the second cooling stage 14 of the refrigerator 50 are inserted through the refrigerator mounting opening 42 in the direction perpendicular to the central axis of the radiation shield 40. The radiation shield 40 is fixed to the first cooling stage 13 so as to be thermally connected to the stage, at the refrigerator mounting opening 42.

As an alternative to the direct mounting of the radiation shield 40 to the first cooling stage 13, the radiation shield 40 may be mounted to the first cooling stage 13 by a connecting sleeve. The sleeve is, for example, a heat transfer member for surrounding one end of the second cylinder 12 to the first cooling stage 13 and for thermally connecting the radiation shield 40 to the first cooling stage 13. With this structure, as compared to the direct mounting of the radiation shield 40 to the first cooling stage 13, the second cylinder 12 can be lengthened. Thus, the temperature difference between the first cooling stage 13 and the second cooling stage 14 can be increased.

An explanation on the operations of the cryopump 10 with the aforementioned configuration will be given below. In operating the cryopump 10, the inside of the vacuum chamber is first rough-pumped to approximately 1 Pa by an appropriate roughing pump before starting the operation. Thereafter, the cryopump 10 is operated. By driving the refrigerator 50, the first cooling stage 13 and the second cooling stage 14 are cooled, thereby the radiation shield 40, the baffle 62, and the cryopanel 60, which are thermally connected to the stages, are also cooled.

The cooled baffle 62 cools the gas molecules flowing from the vacuum chamber into the cryopump 10 such that a gas whose vapor pressure is sufficiently low at the cooling temperature (e.g., water vapor or the like) will be condensed and pumped on the surface of the baffle 62. A gas whose vapor pressure is not sufficiently low at the cooling temperature of the baffle 62 enters into the radiation shield 40 through the baffle 62. Of the entering gas molecules, a gas whose vapor pressure is sufficiently low at the cooling temperature of the cryopanel 60 will be condensed and pumped on the surface of the cryopanel 60. A gas whose vapor pressure is not sufficiently low at the cooling temperature (e.g., hydrogen or the like) is adsorbed and pumped by an adsorbent, which is adhered to the surface of the cryopanel 60 and cooled. In this way, the cryopump 10 can attain a desired degree of vacuum in the vacuum chamber.

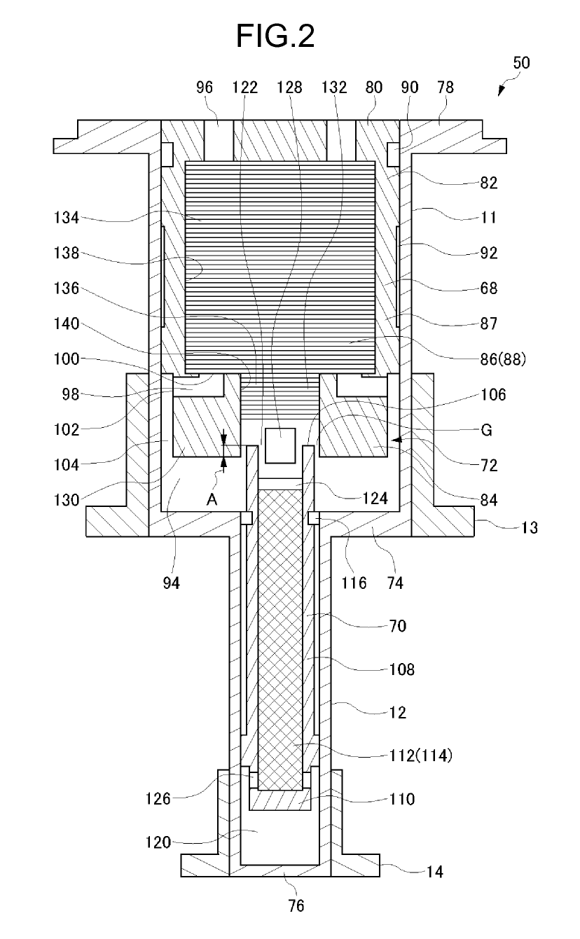

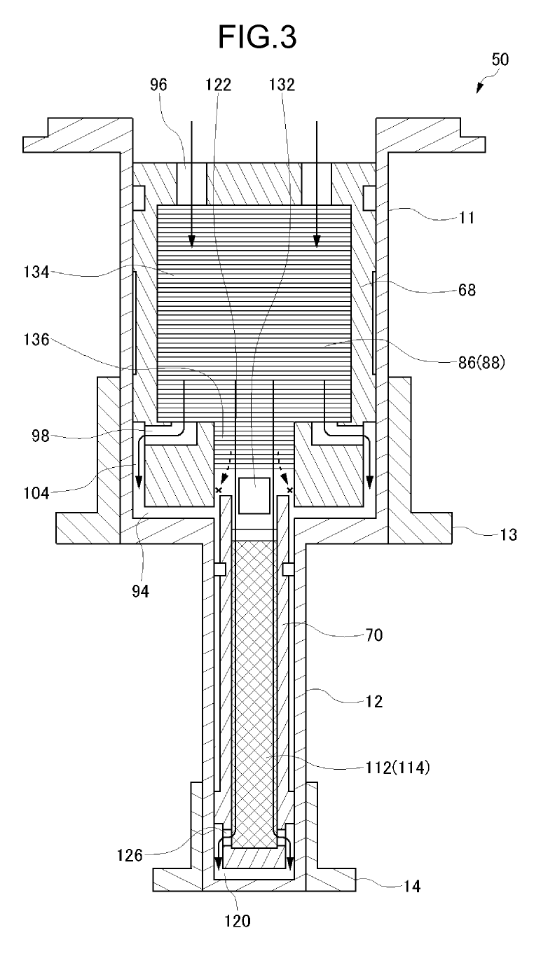

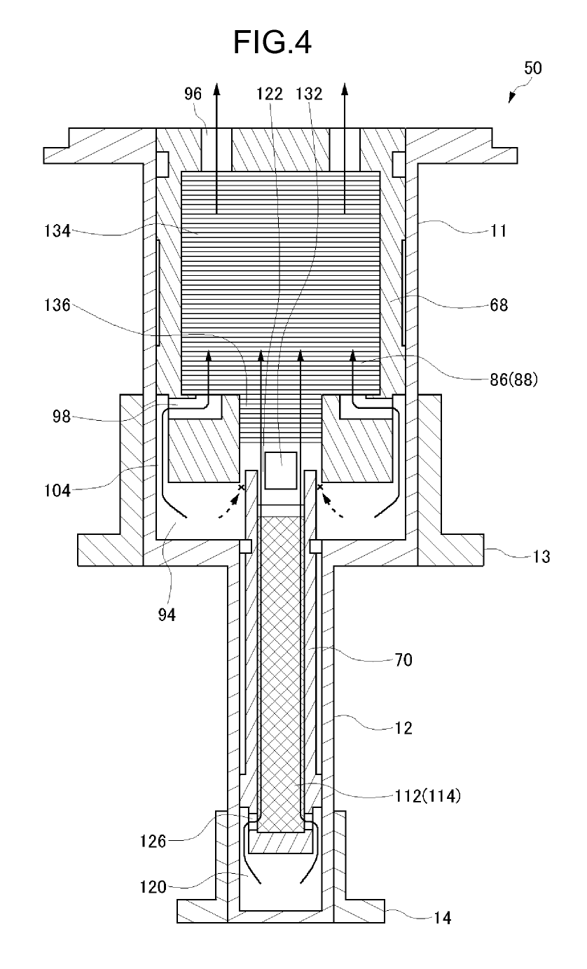

FIGS. 2 to 4 show a substantial part of the refrigerator 50 according to the exemplary embodiment of the present invention. Respective figures show a cross sectional view including the central axis of the refrigerator 50. FIG. 3 schematically shows with arrows flows of operating gas during a gas intake process, and FIG. 4 schematically shows with arrows flows of the operating gas during a gas release process.

The refrigerator 50 includes the first displacer 68 and the second displacer 70 that are adjacent to each other along the direction of the central axes (i.e., longitudinally). The high temperature first displacer 68 and the low temperature second displacer 70 are coupled by a joint unit 72. The refrigerator 50 includes a displacer coupling structure wherein a high temperature end (upper end in the figures) of the second displacer 70 protrudes into a low temperature end of the first displacer 68 to some extent and is coupled.

As will be described specifically later, the first displacer 68 includes a first regenerator 88. The first regenerator 88 includes a cooling path for cooling the operating gas flowing in from the high temperature side and sending it toward the low temperature side. The first regenerator 88 includes a regenerator material 86 suitable for the high temperature displacer and a regenerator housing 87 for the regenerator material 86. The first regenerator 88 can be divided into the main regenerator 134 and the auxiliary regenerator 136. The direct flow passage for guiding the operating gas from the first displacer 68 to a second regenerator 114 through the main regenerator 134 and the auxiliary regenerator 136 is formed. By providing the auxiliary regenerator 136, the first regenerator 88 is configured such that a cooling path for delivering the operating gas to the second regenerator 114 becomes longer than a cooling path for delivering the operating gas to the first expansion space 94.

A hollow structure of the first displacer 68 also functions as the regenerator housing 87. The regenerator housing 87 includes a main compartment 138 and an auxiliary compartment 140 in which the regenerator material 86 is filled. The main compartment 138 accommodates the main regenerator 134, and the auxiliary compartment 140 accommodates the auxiliary regenerator 136. The auxiliary compartment 140 is provided on the low temperature side of the main compartment 138 so that the gas can flow between the main compartment 138 and the auxiliary compartment 140. The auxiliary compartment 140 has a cross-sectional area in a plane perpendicular to a longitudinal direction smaller than that of the main compartment 138. In this way, it is possible to form an independent flow passage, for guiding the operating gas from the main regenerator 134 toward the first expansion space 94, outside the auxiliary compartment 140 and separately from the direct flow passage.

The first cylinder 11 and the second cylinder 12 are formed integrally and the low temperature end of the first cylinder 11 and the high temperature end of the second cylinder 12 are connected by a first cylinder bottom 74. The first cylinder 11 and the second cylinder 12 are arranged in series along the longitudinal direction of the cylinders. The second cylinder 12 is a cylindrical member that is arranged coaxially with the first cylinder 11 and has a smaller diameter than that of the first cylinder 11. The first cylinder 11 contains the first displacer 68 while allowing the first displacer 68 to move to and fro and the second cylinder 12 contains the second displacer 70 while allowing the second displacer 70 to move to and fro.

At the outer circumference of the low temperature end of the first cylinder 11, the first cooling stage 13 is attached and at the outer circumference of the low temperature end of the second cylinder 12, the second cooling stage 14 is attached. The first cylinder bottom 74 is a circular ring-shaped member that connects the first cylinder 11 and the second cylinder 12 with each other at their respective ends. The low temperature end of the second cylinder 12 is closed by a second cylinder bottom 76. At the outer circumference of the high temperature end of the first cylinder 11, a flange 78 is formed.

Adjacent to the high temperature end of the first cylinder 11, a drive mechanism comprising a valve drive motor 16, a rotary valve, and a Scotch Yoke mechanism is provided (not shown). The first displacer 68 is connected to the Scotch Yoke mechanism. The Scotch Yoke mechanism is driven by the valve drive motor 16. A rotational motion of the motor is changed into a linear reciprocating motion by the Scotch Yoke mechanism. Thereby the first displacer 68 moves to and fro along the inner surface of the first cylinder 11. Since the first displacer 68 and the second displacer 70 are coupled, the second displacer 70 also moves to and fro along the inner surface of the second cylinder 12, in synchronization with the first displacer 68.

The first displacer 68 is a member formed into a substantially cylindrical shape corresponding to the dimensions of the inner volume the first cylinder 11. The outer diameter of the first displacer 68 at the thickest portion thereof is substantially same as or slightly smaller than the inner diameter of the first cylinder 11. Thereby, the first displacer 68 can slide along the first cylinder 11, or can move without contact, while leaving a slight gap.

The first displacer 68 is configured to include a first high temperature end 80, a first cylindrical portion 82, and a first low temperature end 84. The first high temperature end 80 and the first low temperature end 84 close the end surfaces of the first cylindrical portion 82 respectively, the end surfaces being opposite each other. As will be described later, an opening for connecting the inside and the outside of the first displacer 68 is formed on each of the first high temperature end 80 and the first low temperature end 84.

A circular groove for attaching a seal is formed on the outside in the radial direction at a portion of the first displacer 68 where the first high temperature end 80 and first cylindrical portion 82 are jointed, and a circular ring-shaped first seal 90 is attached in the groove. The first seal 90 closely contacts with the first cylinder 11 slidably, so as to block the flow of the operating gas at the outside of the first displacer 68 between the high temperature end of the first cylinder 11 and the first expansion space 94. At the outer circumference of the first cylindrical portion 82 of the first displacer 68, a fairly shallow concave portion 92 is formed in order to increase the thermal insulation against the outside of the cylinder.

The first stage regenerator material 86 is filled in the first cylindrical portion 82. The regenerator material 86 is a laminated body of metal (e.g., copper or an alloy of copper and another metal such as zinc) meshes, for example. Alternatively, the regenerator material 86 may be a laminated body of plates made of such metal and having a large number of openings. The inner volume of the first displacer 68 surrounded by the first high temperature end 80, the first cylindrical portion 82, and the first low temperature end 84 can also be referred to as a first regenerator 88 that holds the regenerator material 86.

In the first displacer 68, the main compartment 138 and the auxiliary compartment 140 are defined. The main compartment 138 is surrounded by the first high temperature end 80, the first cylindrical portion 82, and the first low temperature end 84 and occupies most of the volume of the first displacer 68. The auxiliary compartment 140 is a space continuous with the low temperature side of the main compartment 138 and is formed in the first low temperature end 84. The auxiliary compartment 140 may be a single opening or a plurality of openings for connecting the main compartment 138 to the outside of the first displacer 68.

The main compartment 138 is a cylindrical space having a large diameter and the auxiliary compartment 140 is a cylindrical space having a smaller diameter than that of the main compartment 138. The main compartment 138 and the auxiliary compartment 140 are arranged concentrically and the auxiliary compartment 140 is connected to a central portion of a low temperature side of the main compartment 138. The auxiliary compartment 140 is at least apart of a concave portion 132 for receiving the second displacer 70 into the first displacer 68. For example, The auxiliary compartment 140 is a part of the concave portion 132 between a connector member 128 and the main compartment 138.

The same type of regenerator material 86 is filled in each of the main compartment 138 and the auxiliary compartment 140. The regenerator material 86 filled in the main compartment 138 forms the main regenerator 134 and the regenerator material 86 filled in the auxiliary compartment 140 forms the auxiliary regenerator 136. The auxiliary regenerator 136 is a regenerator material extension portion extending in the concave portion 132 from the main regenerator 134 toward the second displacer 70. In other words, the first displacer 68 includes the regenerator material extension portion in the first low temperature end 84.

The regenerator material of the auxiliary regenerator 136 may be held by a support (not shown) protruding from an internal wall of the concave portion 132 in the auxiliary compartment 140, for example. Alternatively, the regenerator material of the auxiliary regenerator 136 may be held by using an upper end of the connector member 128 of the joint unit 72 in the auxiliary compartment 140.

Different types of regenerator materials may be filled in the main compartment 138 and the auxiliary compartment 140. Alternatively, at least one of the main compartment 138 and the auxiliary compartment 140 may be further divided into a plurality of sub-compartments for different types of regenerator materials. In this case, a partitioning member or a gap for separating the different types of regenerator materials may be provided at a boundary between the main compartment 138 and the auxiliary compartment 140 or at a boundary between adjacent sub-compartments.

Adjacent to the first low temperature end 84, the first expansion space 94 is formed inside the first cylinder 11. The first expansion space 94 changes its volume during the reciprocating movement of the first displacer 68. The first expansion space 94 is a space surrounded by the first displacer 68, the first cylinder 11, and the second displacer 70. More specifically, the first expansion space 94 is defined by the first low temperature end 84 of the first displacer 68, the internal surface of the first cylinder 11, and a second cylindrical portion 108 of the second displacer 70 that extends from the concave portion 132 of the first displacer 68. The first expansion space 94 and a bottom of the first low temperature end 84 surround a high temperature end 106 of the second displacer 70.

At the first high temperature end 80 of the first displacer 68, a first opening 96 for allowing the operating gas to flow between the outside of the first displacer 68 (i.e., the high temperature side of the first cylinder 11) and the first regenerator 88 is formed. A plurality of first openings 96 are arranged at intervals circumferentially around the central axis.

At the first low temperature end 84 of the first displacer 68, a second opening 98 for allowing the operating gas to flow between the first regenerator 88 and the first expansion space 94 is formed. A plurality of second openings 98 are arranged on the outer periphery of the first low temperature end 84 at intervals circumferentially around the central axis. An inlet part 100 of the second opening 98 is formed at the low temperature end of the first regenerator 88, and an outlet part 102 of the second opening 98 is formed at the side surface of the first low temperature end 84. A bent or curved flow passage is formed from the inlet part 100 to the outlet part 102 in the first low temperature end 84.

The inlet part 100 and the outlet part 102 are merely named as such for the sake of convenience. That is, at the second opening 98, not only the operating gas flowing from the inlet part 100 to the outlet part 102, but also the operating gas flowing from the outlet part 102 to the inlet part 100 are permitted. The second opening 98 may not be the curved flow passage but may also be, for example, a straight through hole formed in the low temperature end of the first regenerator 88, along the direction of the central axis or the direction orthogonal thereto.

The diameter of the first low temperature end 84 of the first displacer 68 is set, to some extent, smaller than that of the low temperature end of the first cylindrical portion 82. Thereby, a circular ring-shaped first passage 104 that connects the second opening 98 and the first expansion space 94 is formed between the side surface of the first low temperature end 84 and the inner surface of the first cylinder 11. The first passage 104 may also be deemed as a part of the first expansion space 94. By the first passage 104, the outlet part 102 of the second opening 98 is connected to the first expansion space 94.

The first passage 104 extends longitudinally along the first cooling stage 13. As shown in the figures, the longitudinal extent of the first cooling stage 13 includes the longitudinal range of movement of the outlet part 102 of the second opening 98. Therefore, regardless of the longitudinal position of the first displacer 68, the outlet part 102 of the second opening 98 faces the first cooling stage 13. In this way, the operating gas flowing through the first passage 104 and the first cooling stage 13 can exchange heat with each other through the first cylinder 11, efficiently.

In this way, a first path of flow for allowing the operating gas to flow from the first displacer 68 through the second opening 98 to the first expansion space 94 is formed. The first path delivers the operating gas from the compressor 52 and the refrigerant pipe 18 (cf. FIG. 1), through the first opening 96, the main regenerator 134, the second opening 98, and the first passage 104, to the first expansion space 94 (cf. FIG. 3). The first path returns the operating gas in the reverse direction from the first expansion space 94 to the compressor 52 (cf. FIG. 4).

The first path described above includes a flow passage independent of the direct flow passage from the first displacer 68 to the second displacer 70. The independent flow passage connects the main regenerator 134 of the first displacer 68 and the first expansion space 94. The first low temperature end 84 of the first displacer 68 includes a portion not facing the second displacer 70. The non-facing portion is an outer circumference portion 130 of the first low temperature end 84 that is exposed to the first expansion space 94. The independent flow passage is formed in the non-facing portion. In this manner, the independent flow passage is separated from the direct flow passage formed in a portion of the first low temperature end 84 that faces the second displacer 70.

The second displacer 70 is a member formed into a substantially cylindrical shape corresponding to the dimensions of the inner volume of the second cylinder 12. The outer diameter of the second displacer 70 at the thickest portion thereof is substantially same as or slightly smaller than the inner diameter of the second cylinder 12. Thereby, the second displacer 70 can slide along the second cylinder 12, or can move without contact, while leaving a slight gap.

The second displacer 70 is configured to include the second high temperature end 106, the second cylindrical portion 108, and a second low temperature end 110. The second high temperature end 106 and the second low temperature end 110 close the end surfaces of the second cylindrical portion 108 respectively, the end surfaces being opposite each other. As will be described later, an opening for connecting the inside and the outside of the second displacer 70 is formed on each of the second high temperature end 106 and the second low temperature end 110.

A second stage regenerator material 112 is filled in the second cylindrical portion 108. The inner volume of the second displacer 70 surrounded by the second high temperature end 106, the second cylindrical portion 108, and the second low temperature end 110 can also be referred to as a second regenerator 114 holding the regenerator material 112. At the high temperature side of the second regenerator 114, a piece of felt or a metal mesh 124 for holding the regenerator material 112 is provided. In a similar manner, a piece of felt or a metal mesh for holding the regenerator material 112 may be contained in the low-temperature end.

A circular groove for attaching a seal is formed on the outside in the radial direction of the second cylindrical portion 108 of the second displacer 70, and a circular ring-shaped second seal 116 is attached therein. The second seal 116 closely contacts with the second cylinder 12 slidably over the movable range of the second displacer 70, so as to block the flow of the operating gas at the outside of the second displacer 70 between the first expansion space 94 and a second expansion space 120. At the outer circumference of the second cylindrical portion 108 of the second displacer 70, a fairly shallow concave portion 118 is formed in order to increase the thermal insulation against the outside of the cylinder. Adjacent to the second low temperature end 110, the second expansion space 120 is formed inside of the second cylinder 12. The second expansion space 120 changes the volume thereof during the reciprocating movement of the second displacer 70.

At the second high temperature end 106 of the second displacer 70, a third opening 122 for allowing the operating gas to flow between the outside of the second displacer 70 (i.e., the low temperature side of the first displacer 68) and the second regenerator 114 is formed. A plurality of third openings 122 are provided at intervals circumferentially around the central axis. Alternatively, the third opening 122 is provided continuously around the axis.

At the second low temperature end 110 of the second displacer 70, a fourth opening 126 for allowing the operating gas to flow between the second regenerator 114 and the second expansion space 120 is formed. A plurality of fourth openings 126 are provided at intervals at the side surface of the second low temperature end 110. Also a flow passage that connects the fourth opening 126 to the second expansion space 120 is provided along the second cooling stage 14 in a similar manner to the first passage 104. Thereby the operating gas flowing from the second expansion space 120 to the second regenerator 114 and the second cooling stage 14 can effectively exchange heat with each other.

As described above, the first displacer 68 and the second displacer 70 are coupled with each other along the longitudinal direction thereof by the joint unit 72. The joint unit 72 includes the connector member 128. The first low temperature end 84 of the first displacer 68 and the second high temperature end 106 of the second displacer 70 are coupled via the connector member 128 of a cylindrical column shape or a polygonal column shape.

Two coupling pins, oriented orthogonal to each other, are inserted through at the ends of the connector member 128, respectively. One pin couples the first low temperature end 84 of the first displacer 68 and the connector member 128, and the other pin couples the second high temperature end 106 of the second displacer 70 and the connector member 128. The directions of insertion of the two pins are both orthogonal to the longitudinal direction of the refrigerator 50. According to an exemplary embodiment, the joint unit 72 may include a so-called universal coupling joint.

In this way, the first displacer 68 and the connector member 128 are swingably coupled with one of the coupling pins. In the direction orthogonal thereto, the second displacer 70 and the connector member 128 are swingably coupled with the other coupling pin. Thus, when the first displacer 68 and the second displacer 70 are inserted into the first cylinder 11 and the second cylinder 12 respectively during the assembling process of the refrigerator 50, the second displacer 70 can move or can be decentered with respect to the first displacer 68 to some extent. Therefore, the tolerance of the manufacturing process of the cylinders is relaxed, which contributes to the cost reduction of the refrigerator 50.

The first low temperature end 84 of the first displacer 68 has the outer circumference portion 130. The outer circumference portion 130 is formed as a circular shaped convex portion that protrudes from the first cylindrical portion 82 toward the first cylinder bottom 74. The side surface of the outer circumference portion 130 is also the side surface of the first low temperature end 84. Thus, the side surface of the outer circumference portion 130 faces the inner surface of the first cylinder 11, and the first passage 104 described above is formed between the side surface of the outer circumference portion 130 and the inner surface of the first cylinder 11, accordingly. The central portion surrounded by the outer circumference portion 130 is a concave portion 132. The concave portion 132 is open to the first regenerator 88. The outer circumference portion 130 surrounds at least one opening forming the auxiliary compartment 140.

The connector member 128 is arranged in the concave portion 132 and at least apart of an upper portion of the connector member 128 is contained in the concave portion 132. There is a gap between an upper end of the connector member 128 and the auxiliary regenerator 136, thus the connector member 128 and the auxiliary regenerator 136 do not contact with each other. The joint portion of the connector member 128 coupling with the second displacer 70 is contained in the third opening 122 of the second displacer 70. There is a gap between the lower end of the connector member 128 and the second regenerator 114 or the metal mesh 124, thus the connector member 128 and the second regenerator 114 or the metal mesh 124 do not contact with each other.

The concave portion 132 of the first low temperature end 84 is formed in order to receive the second displacer 70. The high temperature side of the second displacer 70, more specifically, the second high temperature end 106 is loosely inserted into the concave portion 132, i.e., inserted with a play to some extent. Therefore, a gap G is formed between the side surface of the concave portion 132 and the side surface of the second high temperature end 106 of the second displacer 70. The difference between the diameter of the concave portion 132 and the diameter of the second cylindrical portion 108 defines the gap G. The gap G is comparable to or less than 0.5 mm. As shown in the figures, the high temperature end 106 of the second displacer 70 protrudes further than the end surface of the first low temperature end 84 by a length A. The amount of the protrusion is at the longest, 15 mm or 10 mm, for example.

Thus, the direct flow passage is formed for allowing the operating gas to flow from the first displacer 68 through the concave portion 132 to the second displacer 70. The direct flow passage includes an intermediate part connecting the main regenerator 134 of the first displacer 68 and the regenerator 114 of the second displacer 70. The intermediate part in the direct flow passage is formed at a facing portion of the low temperature end 84 of the first displacer 68, which directly faces the second displacer 70. The intermediate part includes at least one opening provided with the auxiliary regenerator 136.

The direct path of flow is used to deliver the operating gas from the compressor 52 and the refrigerant pipe 18 (cf. FIG. 1), through the first opening 96, the main regenerator 134, the auxiliary regenerator 136, the concave portion 132, the third opening 122, the second regenerator 114, and the fourth opening 126, to the second expansion space 120 (cf. FIG. 3). Further, the direct path is used to return the operating gas in the reverse direction from the second expansion space 120 to the compressor 52 (cf. FIG. 4).

A dimension of the gap G is adjusted so that the operating gas flowing through the direct flow passage is dominant in the flow of the operating gas between the first displacer 68 and the second displacer 70. In this way, a leakage through the gap G of the operating gas flowing between the first regenerator 88 and the second regenerator 114 can be restrained. The amount of the operating gas directly flowing from the first regenerator 88 to the second regenerator 114 without passing through the first expansion space 94 can be increased.

The gap G connects from the concave portion 132 to the first expansion space 94. However, a dimension of the gap G is adjusted so that the operating gas flowing through the second opening 98 dominates the flow of the operating gas between the first expansion space 94 and the first displacer 68. That is, the operating gas flowing from the first displacer 68 through the second opening 98 to the first expansion space 94 is returned to the first displacer 68 by passing through the second opening 98 again. The flow of gas flowing via the first expansion space 94 through the gap G into the concave portion 132 is sufficiently restrained.

Preferably, the gap G at the portion of the second displacer 70 protruding into the first displacer 68 may be sealed so that the operating gas substantially cannot flow through the gap G. At least a portion of the gap G may be completely closed by swinging of the first displacer 68 and the second displacer 70 in the assembling process of the refrigerator 50. Alternatively, a seal member may be attached into a position of the gap G corresponding to the first displacer 68 or the second displacer 70 to block the flow of the gas through the gap G. The first displacer 68 and the second displacer 70 may be connected by a bellows so that the flow of the gas through the gap G is blocked. The first displacer 68 and the second displacer 70 may be molded integrally so that the whole or a part of the gap G is completely blocked.

In this way, the flow of the operating gas to the first expansion space 94 and the flow of the operating gas to the second expansion space 120 are separated from each other. Therefore, the operating gas that flows into the first expansion space 94 and exchanges heat with the first cooling stage 13 is restrained from flowing into the second displacer 70. The operating gas being supplied from the first displacer 68 and heading directly to the second expansion space 120 does not pass through the first expansion space 94. In this way, the effect on the cooling capability of the second stage due to the cooling temperature of the first stage of the refrigerator 50 can be reduced.

The aforementioned structure for providing the flow separation is particularly preferable in case where a large temperature difference between the different cooling stages is required. In case that the operating gas passes through a cooling stage that is cooled to a comparatively high temperature and a heat exchanger (i.e., an expansion space) of the cooling stage and heads for a next cooling stage of comparatively low temperature and a heat exchanger thereof, the effect that the high temperature of the upstream stage gives to the downstream stage becomes large. By separating the flow, the effect given to the cooling capability of the downstream stage can be restrained.

Therefore, for example, for the refrigerator 50 having two stages, it is preferable to adopt the aforementioned flow-separating structure in case the cooling temperature of the first stage is set to be equal to or more than 80 K, preferably equal to or more than 100 K, and the cooling temperature of the second stage is set to be equal to or less than 30 K, preferably equal to or less than 20 K. Alternatively, it is preferable to adopt the flow-separating structure in case the temperature difference between the stages adjacent to each other is large, for example, at least 50 K or more, preferably 80 K or more.

The respective flow passages are configured so that the direction of the flow of the operating gas flowing out from the first displacer 68 through the direct flow passage to the second expansion space 120 and the direction of the flow of the operating gas flowing out from the first displacer 68 and heading to the first expansion space 94 are aligned in parallel. At least the entrance of the independent flow passage from the main regenerator 134 is oriented so that the direction of the flow of gas out from the main regenerator 134 to the independent flow passage is aligned in parallel with the direction of the flow of gas out from the main regenerator 134 to the direct flow passage.

For this purpose, the concave portion 132 is formed so that the flow of gas heading from the first regenerator 88 to the second regenerator 114 flows longitudinally, and the inlet part 100 of the second opening 98 is also formed so that the flow of gas from the first regenerator 88 flows longitudinally. The concave portion 132 and the inlet part 100 of the second opening 98 are openings formed in parallel to the central axis of the cylinder. As described above, the operating gas flow into the second opening 98 is bent and directed into the outward radial direction inside the second opening 98 and flows out from the outlet part 102. That is, the direction of the flow of gas is changed outside of the first regenerator 88.

In this way, the openings are formed so that the directions of the flows of gas running from the low temperature end of the main regenerator 134 of the first regenerator 88 to the outside are aligned in parallel. Thereby, the uniformity of the flows of operating gas at the low temperature end of the main regenerator 134 can be improved. By improving the uniformity of the flows of the operating gas, the uniformity of the temperature distribution at the low temperature end of the first regenerator 88 is refined. This can be helpful to maintain the low temperature globally over the low temperature end of the first regenerator 88.

In the regenerator structure of the first displacer 68 according to the exemplary embodiment, the cooling path or the heat exchange path for cooling the operating gas flowing in from the high temperature side is locally extended. On the other hand, a typical regenerator has a simple cylindrical shape so that the lengths of these paths from the inlet to the outlet of the operating gas are uniform.

In the regenerator structure according to the exemplary embodiment, because the auxiliary regenerator 136 is added in the longitudinal direction, the cooling path in the region facing the second displacer 70 is longer than the cooling path in the other area including the region facing the first expansion space 94. Because the operating gas having the lower temperature can be supplied to the second displacer 70, the cooling capability of the second stage of the refrigerator 50 can be increased. The gas supplied to the first expansion space 94 is at the comparatively high temperature and therefore the temperature difference between the first stage and the second stage of the refrigerator 50 can be increased.

Because the auxiliary regenerator 136 is formed inside the first displacer 68, the shape and the size of an existing cylinder can be unchanged. Therefore, the movable range of the displacers (so-called “stroke”) can also be maintained, and no change is required in the design of the drive mechanism of the refrigerator 50. Further, since the shape and the size of an existing cylinder, i.e., the external dimensions of the refrigerator 50 can be unchanged, an effect on the structural design of an apparatus to which the refrigerator 50 is applied is limited or absent. For example, in the cryopump 10, the pumping capability of the low temperature cryopanel 60 can be increased while the positional relation between the radiation shield 40 and the low temperature cryopanel 60 is maintained.

An explanation will be given on the operation of the refrigerator 50. The intake process shown in FIG. 3 and the release process shown in FIG. 4 are regarded as one cycle and the refrigerator 50 repeats the cycle. At a certain time point during the intake process, the first displacer 68 and the second displacer 70 reach the bottom dead centers of the first cylinder 11 and the second cylinder 12, respectively. At the same time or slightly earlier or later, the discharge side of the compressor 52 and the inner volume of the cylinders are connected with each other by the rotary valve, and a high-pressure operating gas (e.g., a helium gas) from the compressor 52 flows into the first displacer 68, accordingly.

The high-pressure helium gas flows from the first opening 96 to the first regenerator 88, and is cooled by the regenerator material 86. A part of the cooled helium gas flows into the first expansion space 94 through the second opening 98 and the first passage 104. The operating gas flowing into the first expansion space 94 is supplied from the main regenerator 134. It does not pass through the auxiliary regenerator 136.

The rest of the cooled helium gas flows through the concave portion 132 of the first displacer 68, and the third opening 122 of the second displacer 70, into the second regenerator 114. The helium gas flowing into the second regenerator 114 is cooled by both the main regenerator 134 and the auxiliary regenerator 136. The helium gas is further cooled by the regenerator material 112 in the second regenerator 114 and flows through the fourth opening 126 into the second expansion space 120.

In this way, the gas in the first expansion space 94 and the second expansion space 120 becomes high pressure, respectively. By moving the first displacer 68 and the second displacer 70 toward the top dead centers, the first expansion space 94 and the second expansion space 120 are expanded. The expanded first expansion space 94 and the second expansion space 120 are filled with the high-pressure helium gas.

At a certain time point during the release process, the first displacer 68 and the second displacer 70 position themselves at the top dead centers of the first cylinder 11 and the second cylinder 12, respectively. At the same time or slightly earlier or later, the suction side of the compressor 52 and the inner volume of the cylinder are connected with each other by the rotation of the rotary valve. The helium gas in the first expansion space 94 and the second expansion space 120 are depressurized and expanded. By the expansion, the pressure of the helium gas decreases and cooling occurs. The helium gas in the first expansion space 94 absorbs heat from the first cooling stage 13 and thus cools the first cooling stage 13, and the helium gas in the second expansion space 120 absorbs heat from the second cooling stage 14 and thus cools the second cooling stage 14.

The first displacer 68 and the second displacer 70 are moved toward the bottom dead centers and the first expansion space 94 and the second expansion space 120 are reduced, accordingly. The low pressure helium gas is returned from the first expansion space 94, through the first passage 104, the second opening 98, the first regenerator 88, and the first opening 96, to the compressor 52. Further, the low-pressure helium gas is returned from the second expansion space 120, through the fourth opening 126, the second regenerator 114, the third opening 122, the concave portion 132, the first regenerator 88, and the first opening 96, to the compressor 52. In this process, the regenerator material 86 of the first regenerator 88 and the regenerator material 112 of the second regenerator 114 are also cooled.

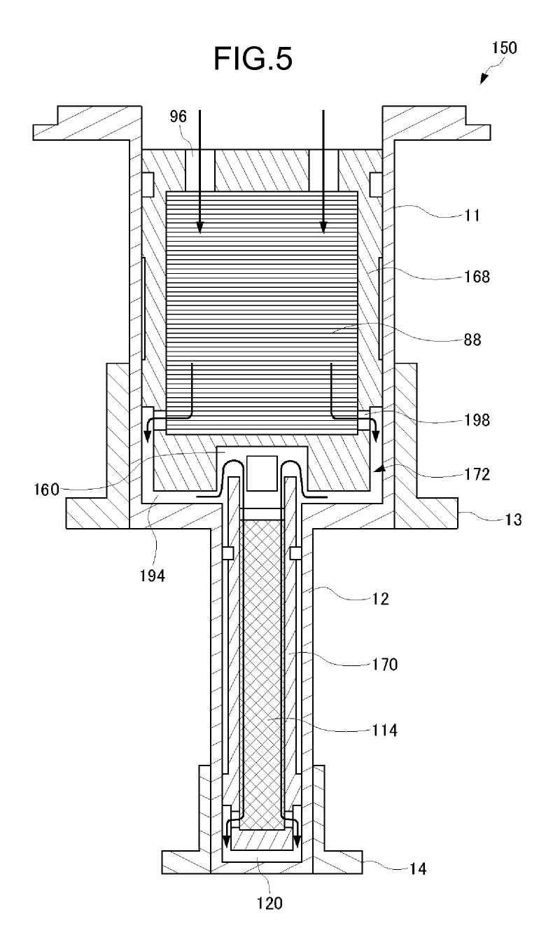

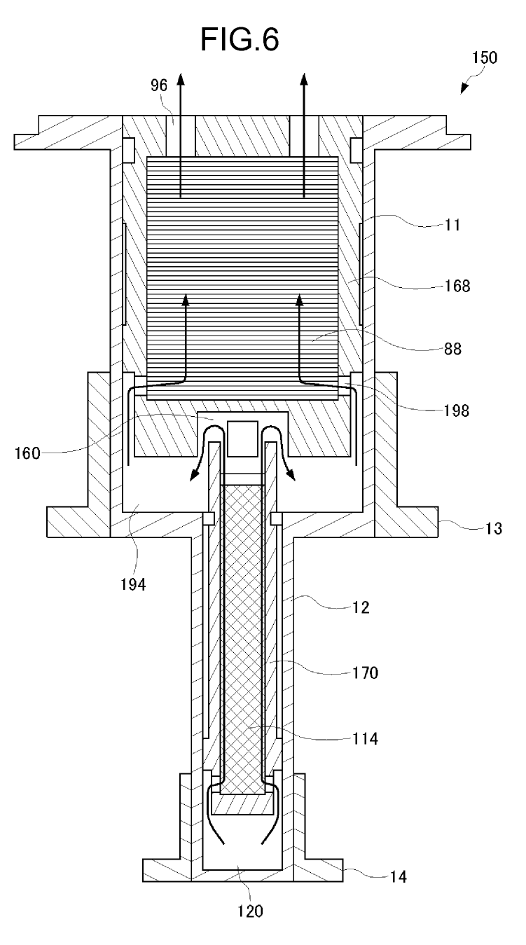

FIG. 5 shows a gas intake process of another typical refrigerator 150, and FIG. 6 shows a gas release process of the refrigerator 150. The structure of the refrigerator 150 differs from that of the aforementioned refrigerator 50 shown in FIG. 2 with respect to a regenerator structure of a first displacer 168. The structure of the refrigerator 150 also differs from that of the refrigerator 50 with respect to a joint unit 172 coupling the first displacer 168 and a second displacer 170. The first cylinders 11, the second cylinders 12, the first cooling stages 13, and the second cooling stages 14 of the refrigerator 50 shown in FIG. 2 and of the refrigerator 150 shown in FIG. 5 and FIG. 6 are of same size and shape.

In the refrigerator 150, a coupling cavity 160, which is a space between the first displacer 168 and the second displacer 170, is formed as a flow passage that connects a first expansion space 194 and a second regenerator 114 as shown in FIG. 5 and FIG. 6. In order to assure a sufficient flow into the second displacer 170, a clearance between the second displacer 170 and the first displacer 168 at the protrusion portion is defined as at least more than 2 mm or 3 mm.

Therefore, during the gas intake process, the flow of the operating gas is supplied through a first opening 96, a first regenerator 88, a second opening 198, the first expansion space 194, the coupling cavity 160, and the second regenerator 114, to a second expansion space 120 (cf. FIG. 5). During the gas release process, the operating gas flows in the reverse direction and returns from the second expansion space 120 to the first opening 96 (cf. FIG. 6). In this way, the flow of the operating gas between the first regenerator 88 and the second regenerator 114 passes through the first expansion space 194. Therefore, the cooling capability of the second stage of the refrigerator 150 is susceptible to the cooling temperature of the first stage.

In the refrigerator 150, the second opening 198 is formed at the low temperature side surface of the first displacer 168 in order to connect the first regenerator 88 of the first displacer 168 to the first expansion space 194. A plurality of second openings 198 are radially formed at intervals on the side surface of the first displacer 168 around the central axis of the refrigerator 150. The second opening 198 may be introduced to the refrigerator 50 shown in FIG. 2.

As will be understood from the comparison with the refrigerator 150 shown in FIG. 5 and FIG. 6, the joint unit 72 of the refrigerator 50 shown in FIGS. 2 to 4 can also be considered to have a seal structure that seals the flow of gas at the gap G connecting from the first expansion space 94, which is adjacent to the first displacer 68, to the second displacer 70.

As an index indicating the sealing performance of the seal structure, the ratio X of a protrusion length A of the second displacer 70 to the gap G can be considered. That is, X=A/G. If the protrusion length A of the second displacer 70 is large and the gap G is small, the value X of the ratio becomes large. In this case, the flow of the operating gas is constrained. Meanwhile, if the protrusion length A of the second displacer 70 is small and the gap G is large, the value X of the ratio becomes small. In this case, the operating gas flows easily.

In an embodiment, in case the protrusion length A is 10 mm and the gap G is 0.5 mm, the ratio X becomes 20. Therefore, the ratio X is preferably equal to or more than 20. In case the protrusion length A is 15 mm and the gap G is 0.5 mm, the ratio X becomes 30. Therefore, the ratio X is preferably, at least 30 or more. In contrast, in case that the protrusion length A is 10 mm and the gap G is 2 to 3 mm such as the case of the refrigerator 150 shown in FIG. 5 and FIG. 6, the ratio X becomes about 3.3 to 5. By setting the ratio value X ten times or more greater than that of the joint portion of a typical refrigerator in the aforementioned manner, sufficient sealing performance can be achieved.

According to a preferable embodiment, the protrusion length A is equal to or less than 15 mm, the gap G is equal to or less than 0.5 mm, and the ratio X is equal to or more than 30. In other words, in order to set the ratio X at 30 or more, the protrusion length A is selected from a range equal to or less than 15 mm and the gap G is selected from a range equal or less than 0.5 mm. With such a structure, sufficient sealing performance on the gap G can be obtained with ensuring a sufficient space of the auxiliary compartment 140 for the auxiliary regenerator 136.

As described above, according to an exemplary embodiment of the present invention, in an arrangement of a refrigerator in which the positions of two cooling stages and the dimensions of cylinders are generally predefined, the auxiliary regenerator 136 is added in the direct flow passage formed from the first displacer 68 to the second displacer 70. When seen in the longitudinal direction, the long portion of the regenerator material 86 is formed at the central part of the first regenerator 88 and the short portion of the regenerator material 86 is formed at the peripheral part of the first regenerator 88. The temperature of the gas to be supplied to the second displacer 70 can be lowered than that of the operating gas that goes to the destination of the first expansion space 94.

This allows the temperature difference between the first stage and the second stage of the refrigerator 50 to increase. Further, the temperature of the gas supplied to the second stage can be lowered so as to increase the cooling capability of the second stage. Since the cryopump 10 includes the radiation shield 40 and the cryopanel 60 therein, whose positional relation is predetermined, the refrigerator 50 aforementioned above can be favorably applied to the cryopump. More specifically, the refrigerator 50 is favorably applied to a cryopump for use in a situation where the temperature difference between the radiation shield 40 and the cryopanel 60 therein is required to be large.

The present invention has been described above based on the exemplary embodiment. As understood by a person skilled in the art, the invention is not limited to the above-described exemplary embodiment, various changes in design can be made, the invention can be modified into various forms, and additionally, the modifications are included in the scope of the invention.

The auxiliary regenerator 136 does not necessarily have to be provided at the low temperature side of the main regenerator 134. The regenerator structure according to an exemplary embodiment of the invention may have a local portion, which is ineffective in terms of heat exchange or has a smaller heat-exchanging effect than the regenerator material, at the high temperature end or any other portion. In this way, the regenerator structure may include an area having a comparatively long cooling path and an area having a comparatively short cooling path. For example, in place of or in addition to the auxiliary regenerator 136, the regenerator structure may have an area without the regenerator material. The cooling path for sending the operating gas out to the adjacent expansion space may include the area without the regenerator material. In this case also, it is possible to obtain a temperature difference between the operating gas heading to the expansion space and the operating gas heading to the low temperature displacer.

The invention may be applied not only to the two-stage refrigerator but also to a multiple-stage refrigerator having more than two stages. In this case, a regenerator structure of the first stage which is at a high temperature side out of the first stage and the second stage adjacent thereto may have the aforementioned auxiliary regenerator 136 or a regenerator structure of the second stage which is at a high temperature side out of the second stage and the third stage adjacent thereto may have the aforementioned auxiliary regenerator 136. The refrigerator according to an exemplary embodiment of the invention may be applied not only to the cryopump but also to an arbitrary target.

It should be understood that the invention is not limited to the above-described embodiment, but may be modified into various forms on the basis of the spirit of the invention. Additionally, the modifications are included in the scope of the invention.

Priority is claimed to Japanese Patent Application No. 2011-128662, filed Jun. 8, 2011, the entire content of which is incorporated herein by reference.

What is claimed is:

1. A cryopump comprising:
a low temperature cryopanel;
a high temperature cryopanel cooled to a temperature higher than that of the low temperature cryopanel; and
a refrigerator arranged to provide a low temperature cooling position for cooling the low temperature cryopanel and a high temperature cooling position for cooling the high temperature cryopanel, the low temperature cooling position and the high temperature cooling position being arranged longitudinally,
wherein the refrigerator comprises a first displacer and a second displacer longitudinally adjacent to a low temperature side of the first displacer,
wherein the first displacer comprises a low temperature end, having a direct flow passage for guiding operating gas from a main regenerator of the first displacer toward a regenerator of the second displacer, and an auxiliary regenerator provided in the direct flow passage.

2. The cryopump according to claim 1, wherein the direct flow passage includes at least one opening formed at a portion of the low temperature end of the first displacer, the portion which faces the second displacer, and the auxiliary regenerator is provided in the at least one opening.

3. The cryopump according to claim 1, wherein the low temperature end of the first displacer comprises a non-facing portion to the second displacer, the non-facing portion having an independent flow passage for guiding operating gas from the main regenerator to an expansion space adjacent to the low temperature end.

4. The cryopump according to claim 3, wherein at least an entrance of the independent flow passage from the main regenerator is oriented so that a direction of an outflow from the main regenerator into the independent flow passage is aligned with a flow direction from the main regenerator to the direct flow passage.

5. The cryopump according to claim 1, wherein the direct flow passage includes a concave portion formed in the low temperature end of the first displacer so as to receive a high temperature end of the second displacer and a gap between the high temperature end and the concave portion is adjusted so that a flow through the direct flow passage is dominant between the first displacer and the second displacer.

6. A cryogenic refrigerator comprising a low temperature displacer and a high temperature displacer adjacent to each other in a longitudinal direction,
wherein the high temperature displacer includes a main compartment and an auxiliary compartment for accommodating a regenerator material,
wherein the auxiliary compartment has a cross-sectional area in a plane perpendicular to the longitudinal direction smaller than that of the main compartment and is provided to allow gas to flow between the main compartment and the low temperature displacer.

7. A cryogenic refrigerator comprising a regenerator including cooling paths for cooling operating gas from a high temperature side to a low temperature side,
wherein the regenerator is configured such that a cooling path for the operating gas toward another regenerator adjacent thereto is longer than a cooling path for the operating gas toward an expansion space adjacent to the regenerator.

8. A cryopump comprising the refrigerator according to claim 6.

9. A cryopump comprising the refrigerator according to claim 7.
